(19) United States
(12) Patent Application Publication
(10) Pub. No.: US 2005/0144155 A1
(43) Pub. Date: Jun. 30, 2005

(54) Stylesheet uploading to manage terminal diversity

(75) Inventor: Bernardus Adrianus Cornelis Van Vlimmeren, Eindhoven (NL)

Correspondence Address: Corporate Patent Counsel;Philips Electonics North America Corporation, P O Box 3001, Briarcliff Manor, NY, 10510, US

(73) Assignee: Koninklijke Philips Electronics N.V.

(21) Appl. No.: 10/503,430

(22) PCT Filed: Jan. 21, 2003
(86) PCT No.: PCT/IB03/00171

(30) Foreign Application Priority Data
Feb. 7, 2002 (EP) 02075528.6

(51) Int. Cl. G06F 17/30

(52) U.S. Cl. 707/2

(57) ABSTRACT

A method and apparatus for formatting content for presentation on a display device coupled to the client system is disclosed. When the client requests the content from the server, the server retrieves the content. The content is then processed at the server using instructions received from the client on how to format the content for the client. The processed content is then transmitted from the server to the client for display on the display device.

### FIELD OF THE INVENTION

The invention relates to the transfer of information over networks such as the Internet, and more particularly to a method and apparatus for facilitating the transfer of data to clients with varying degrees of capability.

### BACKGROUND OF THE INVENTION

In the past years, there has been an explosion in the number of communication systems, such as the Internet, intranet and wireless telecommunication systems just to name a few. This has lead to a large number of different types of consumer devices, e.g., personal computers, mobile telephones, personal digital assistants (PDAs), webphones, televisions, etc., which can be used to communicate over these various networks. These consumer devices have a huge variety of capabilities with respect to their user interface. For example, the user interface of a mobile telephone differs wildly from the man-machine interface of a personal computer, which in turn is very different from the user interface of a digital camera. Indeed, even the capabilities within one type of consumer device, such as mobile telephones, varies greatly depending on the features and upgrades the consumer has selected for the device.

In the near future, all of these various consumer devices will be connected to the same network such as an in-home digital network (such as a HAVi), a wireless variant, the Internet, or a combination of these or other systems. One problem with such a network is how to supply information stored for instance in HTML format to such a wide range of different consumer devices in such a manner that the information can be downloaded and displayed by the different consumer devices.

HTML is not designed to provide an author with direct control over the format of a document. An author may control the format of an HTML document, however, by creating a style sheet for the HTML document. A style sheet is a collection of style definitions which provides instructions for formatting a document. A style sheet does not contain any document content, only instructions for formatting document content. Typically, the document content is displayed on a display device. A style sheet may define the format properties of a document such as font properties (font family, font style, font variant, font weight, font size), color and background properties (background color, background position), text properties (word spacing, letter spacing), and page properties (columns, page margins).

Typically, a style sheet includes a number of style definitions or style rules. Each style definition corresponds to a formatting property such as a font property. A style sheet may be created using a style sheet language such as Cascading Style Sheets (CSS), Document Style Semantics and Specification Language (DSSSL) and Javascript Accessible Style Sheets (JASS). CSS supports cascading style sheets and is specifically designed for the presentation on a display device of documents distributed over a network such as the Internet. To display a document using a style sheet on a client system, the browser on the client system must support the style sheet language.

Several methods for handling the different requirements for different consumer display devices are being used in networks today. First, each client system can be provided with its own limited web-content browser. In this example, when the client requests a document, the server simply delivers the document to the browser in the client. The browser then converts the document into the appropriate format prior to display. This method has several disadvantages. First, the conversion is done by the browser in the client which could be a very time consuming operation particularly in small devices (cellular telephones, PDAs) which have limited processing capabilities. In addition, the server may waste time by sending part or all of a document that may not be able to be displayed on the display device.

A second method for handling the diversity is to store the document in a variety of different formats and then select the correct version for each individual client. Alternatively, the server can store a style sheets for each type of device that may ask for the information. These methods have the disadvantage of requiring the author (content provider) or the server to be familiar with the different requirements of all possible clients.

### SUMMARY OF THE INVENTION

It is an object of the invention to overcome the above-described deficiencies of the prior art by providing a method and apparatus for formatting a document wherein the client provides a set of instructions to a server on how to format the document for the particular client and the server uses the set of instructions to adapt the document for the client before transmission to the client.

According to one embodiment of the invention, a method, in a computer network comprising a server system and a client system, for formatting content for presentation on a display device coupled to the client system is disclosed. When the client requests the content from the server, the server retrieves the content. The content is then processed at the server using instructions received from the client on how to format the content for the client. The processed content is then transmitted from the server to the client for display on the display device.

According to another embodiment of the invention, a server for formatting content for display is disclosed. The server system comprises means for retrieving the content in response to a request for the content from a client with a display device and processing means for processing the document using instructions received from the client on how to format the content for the display device. Transmitting means transmit the processed content to the client system for display on the display device.

According to another embodiment of the invention, a computer program product for formatting content for display is disclosed.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a computer network according to one embodiment of the invention;

FIG. 2 is a flow chart illustrating a method for formatting content for display according to one embodiment of the invention;

FIG. 3 is a block diagram of a computer network according to one embodiment of the invention;

FIG. 4 is a flow chart illustrating a method for formatting content for display according to one embodiment of the invention.

### DETAILED DESCRIPTION OF THE INVENTION

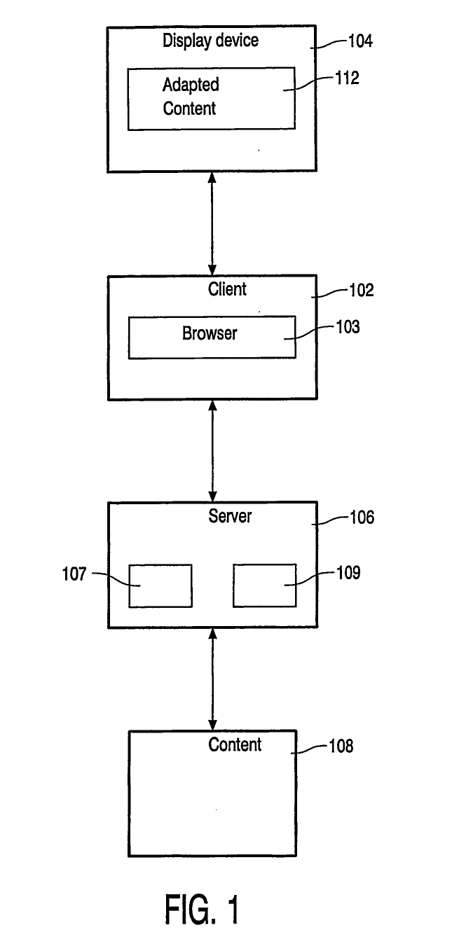

FIG. 1 illustrates a computer network for formatting content for display according to one embodiment of the invention. The network comprises a client 102 and a server 106. The client 102 may be a personal computer, mobile telephone, PDA, webphone, television, etc., and the server 106 may be a remote computer operating in a networked environment. Servers are well known in the art and will not be full described herein. The server 106 comprises, among other features, transmitting and receiving means 107 for transmitting and receiving information over the networked environment and at least one processor 109 for processing the information in various ways. Alternatively, processing devices external from the server 106 could also be used to process the information. In addition, the server can be assisted in the processing by a layout generator attached, for example, to the requested content.

The client renders a document (content) 108 obtained from a remote storage device on an output device 104 coupled to the client 102 using a presentation component such as a browser 103. In this example, the output device 104 is a display device such as a computer screen, a display window on a mobile telephone or PDA, a television screen, etc. The document 108 specifies the content of the document as well as the structure of the document. The document 108 may be an HTML document which uses HTML tags to define the structure of the document.

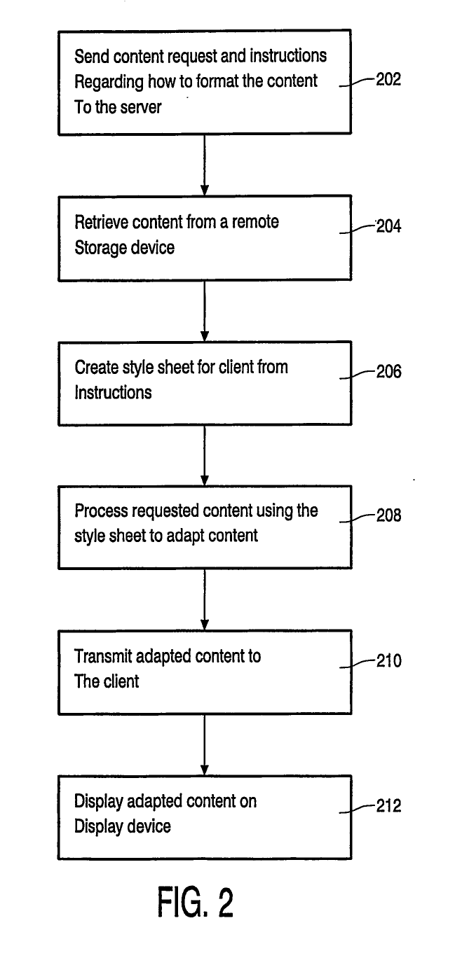

The operation of the above-described network will now be described with reference to the flow chart illustrated in FIG. 2. When a client 102 desires to display content on the display device 104, the client 102 sends a request for the content 108 to the server 106 in step 202. The server then retrieves the content from a remote storage device in step 204. The request for content may also include instructions on how the content should be formatted for the display device 104. The instructions may be a style sheet which had been stored in the client 102, pieces of a language from which the server could create a style sheet from which the content could be formatted in step 206, or a set of instructions to follow for formatting the content. Alternatively, the server 106 could prompt the client 102 for the instructions regarding formatting of the content if the instructions are not sent with the content request.

Once the server 106 has retrieved the content 108 and either created or uploaded a style sheet from the client 102, the server 106 processes the content 108 using the style sheet or instructions to adapt the content 108 for display on the display device 104 in step 208. Once the content 108 has been adapted, the adapted content 112 is sent to the client 102 from the server 106 in step 210. The adapted content 112 can then be displayed on the display device 104 in step 212.

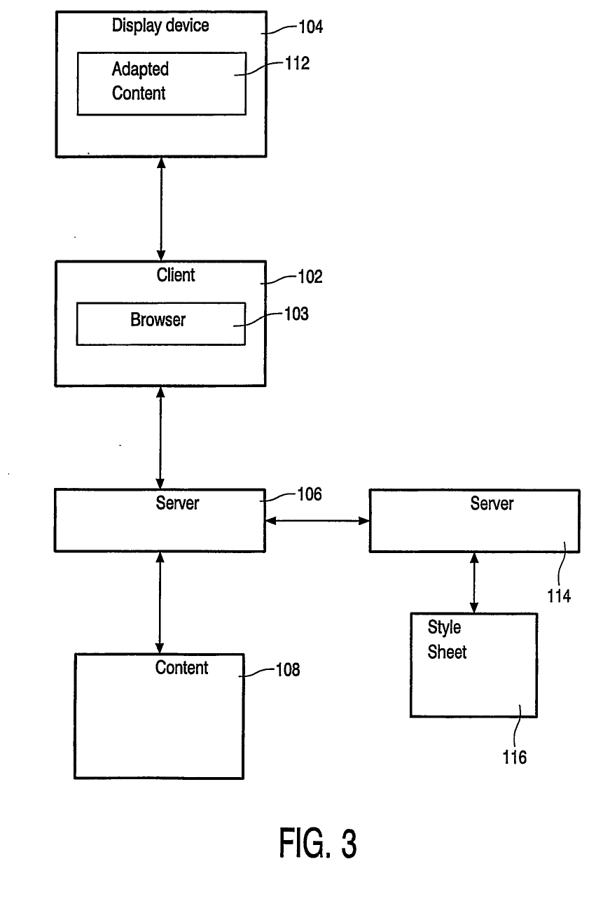

FIG. 3 illustrates a variation of the computer network disclosed in FIG. 1, wherein the same reference numerals are used for like elements. In this embodiment, a style sheet 116 for the client 102 has been saved on an external server 114. For example, the external server 114 could be maintained by the vendor of the client device, wherein the vendor creates and stores style sheets for various models and types of client devices. Furthermore, an individual client may be allowed to go to the external server 114 and customize the style sheet the vendor has created for that type of client. For example, the style sheet could be shared in whole or in part between client devices, for example, using the cascading mechanism known from Cascading Style Sheets. Then, the client device vendor could offer a generic style sheet for all such client devices on its web site, and individual client devices could then customize the generic style sheet. The customized style sheet for the particular client can then be stored at the external server 114 or a remote storage device connected to the external server 114.

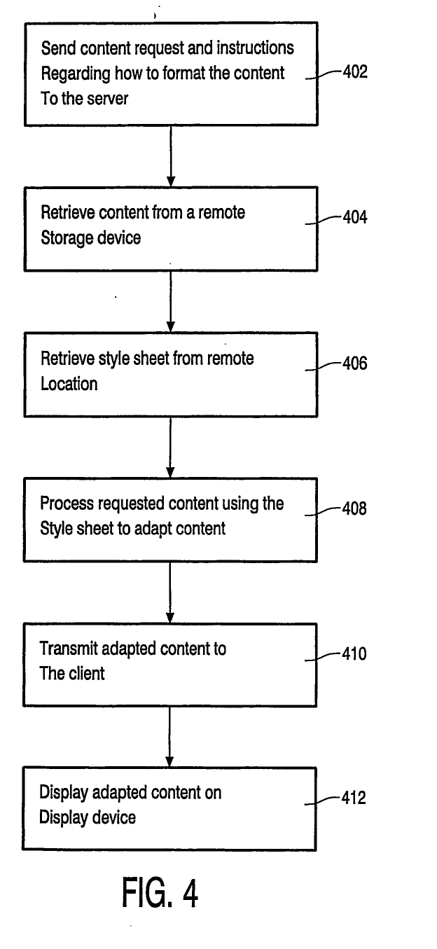

The operation of the network illustrated in FIG. 3 will now be described with reference to the flow chart illustrated in FIG. 4. When a client 102 desires to display content on the display device 104, the client 102 sends a request for the content 108 to the server 106 in step 402. The server then retrieves the content from a remote storage device in step 404. The request for content may also include instructions on how the content should be formatted for the display device 104. In this embodiment, the instructions include a URL giving the location of a stored style sheet (either generic or customized) that should be used to format the requested content. In addition, the instructions can also include additional style information for revising the stored style sheet. Alternatively, the server 106 could prompt the client 102 for the instructions regarding formatting of the content if the instructions are not sent with the content request.

The server 106 retrieves the stored style sheet 116 from the identified location in step 406. Once the server 106 has retrieved the content 108 and the stored style sheet from the external server 114, the server 106 processes the content 108 using the style sheet to adapt the content 108 for display on the display device 104 in step 408. Once the content 108 has been adapted, the adapted content 112 is sent to the client 102 from the server 106 in step 410. The adapted content 112 can then be displayed on the display device 104 in step 412.

The above-described embodiments of the invention have several advantages over the previously known systems. First, the amount of data transferred from the server to the client is minimized since the style sheet is presumably arranged such that unnecessary parts of the content are removed, for example, images in a document requested by a mobile telephone, or reduced in size, e.g., a color image is converted to a black and white image for a handheld device with a monochrome screen. In addition, by preprocessing the content at the server, the load on the client is reduced, which is a great advantage for client devices with limited processing capabilities. Furthermore, servers do not need to be familiar with and store style sheets for all possible clients. Finally, by adapting the instructions, the look and feel of the content can be customized and/or adapted to a new standard.

The above-described embodiments of the invention describe a method an apparatus for conveniently formatting content for display on a display device wherein the server preprocesses the content in accordance with instructions received from the client regarding the correct format of the content. It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. In a computer network comprising a server (106) and a client (102), a method for formatting content for presentation on a display device (104) coupled to the client (102), comprising the steps of:
requesting the content from the server (106);
retrieving the content;
processing the content at the server (106) using instructions received from the client on how to format the content for the client (102); and
transmitting the processed content from the server (106) to the client (102) for display on the display device (104).

2. The method for formatting content according to claim 1, wherein said instructions are a style sheet.

3. The method for formatting content according to claim 1, wherein said instructions are an URL with the location of a style sheet which should be used to format the content.

4. The method for formatting content according to claim 3, wherein said location is on an external server (114).

5. The method for formatting content according to claim 1, wherein the instructions are sent to the server (106) with the request for the content.

6. The method for formatting content according to claim 1, wherein said instructions are sent to the server (106) in response to a request from the server.

7. The method for formatting content according to claim 1, wherein the server (106) creates a style sheet for formatting the content from the instructions sent from the client (102).

8. A server system (106) for formatting content for display, comprising
means for retrieving (107) the content in response to receiving a request for the content from a client (102) with a display device (104);
processing means for processing (109) the document using instructions received from the client (102) on how to format the content for the display device (104); and
means for transmitting (107) the processed content to the client (102) for display on the display device (104).

9. The server for formatting content according to claim 10, further being configured to create a style sheet for formatting the content from the instructions sent from the client (102).

10. A computer program product for formatting content for display comprising
processing means for processing (109) a document using instructions received from a client (102) on how to format the content for a display device (104); and
means for transmitting (107) the processed content to a client (102) for display on the display device (104).
